(19) United States
(12) Patent Application Publication
(10) Pub. No.: US 2017/0298167 A1
(43) Pub. Date: Oct. 19, 2017

(54) METHOD FOR PREPARING A GRAFTED UNSATURATED SYNTHETIC RUBBER

(71) Applicant: ARKEMA FRANCE, Colombes (FR)

(72) Inventors: Bin JI, Changshu (CN); Peng DAI, Changshu (CN); Shenglin ZOU, Changshu (CN)

(73) Assignee: ARKEMA FRANCE, Colombes (FR)

(21) Appl. No.: 15/510,535

(22) PCT Filed: Sep. 30, 2015
(86) PCT No.: PCT/IB2015/001665

§ 371 Date: Mar. 10, 2017

(30) Foreign Application Priority Data
Sep. 12, 2014 (CN) PCT/CN2014/086402

(51) Int. Cl. C08F 279/02

(52) U.S. Cl. CPC C08F 279/02

(57) ABSTRACT

A method for preparing a synthetic rubber, including a step of graft-polymerizing a main polymer with a methyl-methacrylate monomer in the presence of a peroxide initiator of formula (I): R₁—O—O—R₂, wherein each of R₁ and R₂ is independently an alkyl group or an alkanoyl group including from 1 to 30 carbon atoms.

### TECHNICAL FIELD

The present invention relates to a method for preparing an environmental friendly Methyl methacrylate-grafted unsaturated synthetic rubber. With this new initiator, the conversion rate of monomers is increased, and there is also no benzene decomposition from decomposition of peroxide. Such kind of adhesive is used for shoes and bags, especially for PVC artificial leather, PU leather with EVA, PE foaming materials.

### TECHNICAL BACKGROUND

Methyl methacrylate-grafted synthetic rubbers, and in particular methyl methacrylate-grafted chloroprene rubbers, have various useful industrial applications, notably as adhesives—for instance in the shoe and bags industry.

The graft polymerization process usually involves dissolving a synthetic rubber in a solvent and performing graft polymerization with a methyl methacrylate monomer at high temperature in the presence of an initiator.

The most widely used initiator is dibenzoyl peroxide, also more simply called benzoyl peroxide. However, the use of this initiator leads to the production of benzene compounds, which raises health and environmental concerns. Also, by using benzoyl peroxide, the conversion rate of MMA monomer is low. That means large quantity of MMA is left in final adhesive. When the workers use the adhesive, the MMA monomers will evaporate to the air. MMA is toxic to lungs and hazardous in case of inhalation.

Document CN 101781538 B provides an example of the use of benzoyl peroxide in this type of process.

Document CN 1064066 C teaches the use of a mixture of benzoyl peroxide and N,N-dimethylaniline in the same type of process.

Document CN 103045134 A discloses the use of a mix of additives including titanium dioxide, calcium carbonate, zinc oxide, etc., still together with a benzoyl peroxide initiator.

Document CN 1952031 A discloses the use of a mixture of dimethyl carbonate, butyl acetate or ethyl acetate, cyclohexane or methyl cyclohexane and butanone or amyl ketone, for the graft polymerization of chloroprene rubber with methyl methacrylate. This leads to rather poor reaction performances, notably in terms of methyl methacrylate conversion.

Similar methods are taught in document CN 1858140 A.

There is still a need for improved processes for the preparation of grafted synthetic rubbers, in particular thermoplastic rubbers. In particular, there is a need for processes which do not generate harmful benzene compounds, and which have high reaction performances.

### SUMMARY OF THE INVENTION

It is a first object of the invention to provide a method for preparing a synthetic rubber, comprising a step of graft-polymerizing a main polymer with a methyl-methacrylate monomer in the presence of a peroxide initiator of formula (I):

R₁—O—O—R₂, (I)

wherein each of R₁ and R₂ is independently an alkyl group or an alkanoyl group comprising from 1 to 30 carbon atoms.

According to one embodiment, at least one of R₁ and R₂ is an alkanoyl group.

According to one embodiment, at least one of R₁ and R₂ is a t-butyl group.

According to one embodiment, each of R₁ and R₂ comprises from 3 to 20 carbon atoms, preferably from 4 to 20 carbon atoms.

According to one embodiment, the peroxide initiator is selected from lauroyl peroxide, didecanoyl peroxide, 2,5-dimethyl-2,5-di(2-ethylhexanoylperoxy)-hexane, t-butyl peroxypivalate and t-butyl peroxy-2-ethylhexanoate and combinations thereof, and is more preferably t-butyl peroxy-2-ethylhexanoate.

According to one embodiment, the main polymer is selected from polychloroprene, SBS copolymer and combinations thereof, and is preferably polychloroprene.

According to one embodiment, the method comprises:
dissolving the main polymer in a solvent to provide a reaction mixture;
increasing the temperature of the reaction mixture and adding the methyl-methacrylate monomer and the peroxide initiator to the reaction mixture, in order to perform the graft-polymerization.

According to one embodiment, the solvent is selected from dimethyl carbonate, ethyl acetate, cyclohexane, methylcyclohexane, acetone, toluene and combinations thereof, and is preferably toluene.

According to one embodiment, the graft-polymerization is performed at a temperature from 60 to 120° C., preferably from 70 to 100° C., and more preferably at a temperature of approximately 80° C.

According to one embodiment, the weight ratio of methyl methacrylate monomer to main polymer is from 1:10 to 1:1, preferably from 1:5 to 1:2.

According to one embodiment, the weight ratio of peroxide initiator to methyl methacrylate monomer is from 1:1000 to 1:10, preferably from 1:500 to 1:50 and more preferably from 1:300 to 1:100.

The invention also relates to the rubber obtainable by the above-described method.

The present invention makes it possible to overcome the drawbacks of the prior art. In particular the invention provides a method for the preparation of grafted thermoplastic rubbers which does not generate harmful benzene compounds, and which exhibits high performances.

The method of the invention makes it notably possible to obtain a high methyl methacrylate conversion rate (and therefore makes it possible to lower the methyl methacrylate dosage); a high graft ratio; a short reaction time; and high mechanical performances, such as a high peeling strength. The initiator dosage can also be lowered.

The invention relies on the finding that peroxide compounds of above formula (I), which are devoid of benzoyl or other aryl groups, are very effective initiators for the graft polymerization of chloroprene rubber or the like with methyl methacrylate.

### DESCRIPTION OF EMBODIMENTS

The invention will now be described in more detail without limitation in the following description. Unless specified otherwise, all concentrations and ratios are expressed by weight.

The invention is directed to the preparation of a synthetic rubber, in particular a thermoplastic rubber or thermoplastic elastomer, i.e. a copolymer having both thermoplastic and elastomeric properties.

This rubber comprises a main polymer (which can itself be a copolymer) grafted with methyl methacrylate.

The method of the invention generally comprises dissolving the main polymer in a solvent to provide a reaction mixture. Thereafter, the temperature of the reaction mixture is increased and the methyl-methacrylate monomer and the peroxide initiator are added to the reaction mixture, so as to perform the graft-polymerization of methyl methacrylate on the main polymer.

If the main polymer is provided in the form of a solid, it is usually cut into pieces before being dissolved.

The main polymer used in the context of the invention is primarily polychloroprene (also known as chloroprene rubber). However, other polymers may be used, such as styrene block copolymers and in particular poly(styrene-butadiene-styrene) or SBS rubber.

The preferred example of solvent used in the context of the invention is toluene. Other useful solvents notably include dimethyl carbonate, ethyl acetate, cyclohexane, methylcyclohexane and acetone.

The dissolution of the main polymer into the solvent can be performed for instance at a temperature of from 20 to 60° C., preferably from 30 to 50° C. and more preferably at approximately 40° C.

Thereafter, the temperature of the reaction mixture can be increased and the methyl methacrylate monomer and the initiator can be added. The temperature increase and the addition of methyl methacrylate and initiator can be performed simultaneously or sequentially in any order.

The (increased) temperature of the reaction mixture for the purpose of the graft-polymerization reaction is typically from 60 to 120° C., preferably from 70 to 100° C., and more preferably is approximately 80° C.

The initiator used in accordance with the invention is a peroxide initiator of formula (I):

R₁—O—O—R₂, (I)

wherein each of R₁ and R₂ is independently an alkyl group or an alkanoyl group comprising a total number of carbon atoms from 1 to 30.

Each of R₁ and R₂ can be linear or branched, and the carbon atoms can be substituted or non-substituted. Substituents may notably include alkanoyl substituents or peroxy substituents. Preferably, the initiator consists of carbon, hydrogen and oxygen atoms.

According to one embodiment, each of R₁ and R₂ is a non-substituted, linear or branched alkyl or alkanoyl group.

No aryl group is present in the initiator of the invention.

The preferred total number of carbon atoms in each of R₁ and R₂ is 3 to 20, preferably 4 to 20.

For each initiator, a 1-hour half-life temperature in the relevant solvent (for instance toluene) can be defined: this is the temperature at which the half-life of the initiator in the solvent (i.e. the time after which half of the initiator in a dilute solution has decomposed) is 1 hour.

It has been found that it is desirable to use an initiator having a 1-hour half-life temperature close to the temperature of the graft-polymerization step.

For instance, the initiator is selected so that its 1-hour half-life temperature is from T_{R}−ΔT to T_{R}+ΔT, where T_{R} is the temperature of the graft-polymerization step, and where ΔT is 20° C.; or 15° C., or 10° C.; or 5° C.

According to some embodiments, the initiator is selected so that its 1-hour half-life temperature is from 70 to 100° C., more preferably from 75 to 95° C.

Preferred examples of initiators to be used in connection with the present invention are:
(A) lauroyl peroxide (for example marketed by Arkema under the name Luperox® LP), of formula:

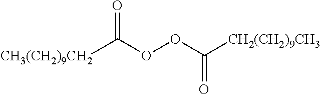

(1-hour half-life temperature of 81° C.);
(B) didecanoyl peroxide (for example marketed by Arkema under the name Luperox® DEC), of formula:

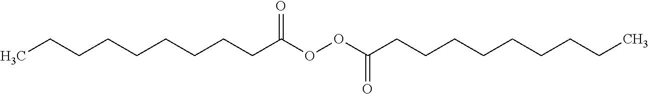 [SMILES: CCCCCCCCCC(=O)OOC(=O)CCCCCCCCC]

(1-hour half-life temperature of 83° C.);
(C) 2,5-dimethyl-2,5-di(2-ethylhexanoylperoxy)-hexane (for example marketed by Arkema under the name Luperox® 256), of formula:

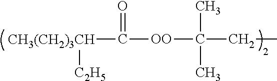

(1-hour half-life temperature of 91° C.);
(D) t-butyl peroxypivalate (for example marketed by Arkema under the name Luperox® 11M75), of formula:

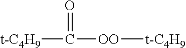

(1-hour half-life temperature of 76° C.);
(E) t-butyl peroxy-2-ethylhexanoate (for example marketed by Arkema under the name Luperox® 26), of formula:

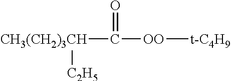

(1-hour half-life temperature of 94° C.).

Instead of a single peroxide initiator, use may be made of combinations of peroxide initiators as described above.

The duration of the graft-polymerization reaction step can typically be from 30 minutes to 24 hours, preferably from 1 hour to 10 hours, more preferably from 2 hours to 6 hours. The duration can be for instance of approximately 4 hours. The reaction is stopped by stopping heating and decreasing the temperature to e.g. 30 to 50° C. Thereafter, inhibitors may be used, such as butylhydroxytoluene.

The weight ratio of methyl methacrylate to main polymer in the reaction mixture can be from 1:10 to 1:9; or from 1:9 to 1:8; or from 1:8 to 1:7; or from 1:7 to 1:6; or from 1:6 to 1:5; or from 1:5 to 1:4; or from 1:4 to 1:3; or from 1:3 to 1:2; or from 1:2 to 2:3; or from 2:3 to 3:4; or from 3:4 to 1:1.

The weight ratio of initiator to methyl methacrylate monomer in the reaction mixture can be from 1:1000 to 1:500; or from 1:500 to 1:300; or from 1:300 to 1:200; or from 1:200 to 1:150; or from 1:150 to 1:100; or from 1:100 to 1:50; or from 1:50 to 1:10.

At the end of the reaction, the reaction mixture can also comprise various additives. Use may in particular be made of inhibitors such as butylhydroxytoluene or hydroquinone to terminate all the left unreacted free radicals.

The grafted rubber obtained according to the method of the invention has improved properties. According to some embodiments, it is notably characterized by a graft ratio of at least 30% and a peeling strength of at least 2000 N/m.

The grafted rubber of the invention can be used in particular as an adhesive, notably for bonding leather substrates, synthetic leather substrates, polyvinyl chloride substrates, polyurethane substrates, ethylene vinyl acetate substrates, etc.

### EXAMPLES

The following examples illustrate the invention without limiting it.

Chloroprene rubber (CR) (DENKA A90) was cut into small pieces and dissolved in toluene at 40° C. Then the temperature was increased to 80° C. and methyl methacrylate (MMA) monomer was added together with an initiator. Two initiators were tested:
Luperox® A75 (by Arkema), i.e. benzoyl peroxide (abbreviated below as LupA75).
Luperox® 26 (by Arkema), i.e. t-butyl peroxy-2-ethylhexanoate (abbreviated below as Lup26).

Different weight ratios were tested. The grafted polymers thus obtained were tested in terms of:
Conversion rate: use is made of a precision balance to weigh the final adhesive solution W₁ (in grams). Then the sample is put in a vacuum oven at 120° C. to remove all solvent for 8 hours. Then the weight after solvent removal W₂ is measured (in grams). The conversion rate is defined as [W₂−W₁/W₀×G]/[W₁×A/W₀], where W₀ is the total weight of raw materials (in g), G is the weight of CR (in g) and A is the weight of monomer (in g).
Graft ratio: this parameter is determined by determining the accurate weight W₂ of the sample after vacuum for 8 hours, cutting the sample to small pieces and putting it in a Soxhlet extractor. Acetone is used as solvent to wash the sample for more than 24 hours. After extraction, the sample is transferred to a vacuum oven at 120° C. for more than 4 hours and the final weight W₃ is measured. The graft ratio (in %) is defined as (W₃−W₄)/(W₂−W₄)×100, where W₄ is the weight of CR in the sample.
Viscosity: use is made of a Brookfield viscometer, at a temperature of 25° C.
Peeling strength: this parameter is measured according to test method ISO 36:2005.

The results are summarized in the table below (tests No. 1-5 are comparative examples, while tests No. 6-8 are according to the invention):

| Test No. | 1 | 2 | 3 | 4 | 5 | 6 | 7 | 8 |
|---|---|---|---|---|---|---|---|---|
| Toluene | 166 | 166 | 166 | 166 | 166 | 166 | 166 | 169.2 |
| amount (g) | | | | | | | | |
| CR | 24 | 24 | 24 | 24 | 24 | 24 | 24 | 24 |
| amount (g) | | | | | | | | |
| MMA | 10 | 10 | 10 | 10 | 10 | 10 | 10 | 6.8 |
| amount (g) | | | | | | | | |
| Initiator | LupA75 | LupA75 | LupA75 | LupA75 | LupA75 | Lup26 | Lup26 | Lup26 |
| type | | | | | | | | |
| Initiator | 0.04 | 0.07 | 0.1 | 0.13 | 0.2 | 0.05 | 0.1 | 0.068 |
| amount (g) | | | | | | | | |
| Conversion | 35.8 | 52.7 | 49.9 | 54.55 | 58.8 | 42.5 | 76.2 | 73.15 |
| rate (%) | | | | | | | | |
| Graft ratio | 5.09 | 17.27 | 17.85 | 21.69 | 33.25 | 34.32 | 35.09 | 30.5 |
| (%) | | | | | | | | |
| Viscosity | 600 | ND | 1100 | 3800 | 500 | 980 | 3065 | 2300 |
| (cps) | | | | | | | | |
| Peeling | ND | ND | 1599 | 2714 | ND | ND | 4566 | 2166 |
| strength | | | | | | | | |
| (N/m) | | | | | | | | |

1. A method for preparing a synthetic rubber, comprising a step of graft-polymerizing a main polymer with a methyl-methacrylate monomer in the presence of a peroxide initiator of formula (I):
R₁—O—O—R₂, (I)
wherein each of R₁ and R₂ is independently an alkyl group or an alkanoyl group comprising from 1 to 30 carbon atoms.

2. The method of claim 1, wherein at least one of R₁ and R₂ is an alkanoyl group.

3. The method of claim 1, wherein at least one of R₁ and R₂ is a t-butyl group.

4. The method of claim 1, wherein each of R₁ and R₂ comprises from 3 to 20 carbon atoms.

5. The method of claim 1, wherein the peroxide initiator is selected from lauroyl peroxide, didecanoyl peroxide, 2,5-dimethyl-2,5-di(2-ethylhexanoylperoxy)-hexane, t-butyl peroxypivalate and t-butyl peroxy-2-ethylhexanoate and combinations thereof.

6. The method of claim 1, wherein the main polymer is selected from polychloroprene, SBS copolymer and combinations thereof.

7. The method of claim 1, comprising:
dissolving the main polymer in a solvent to provide a reaction mixture;
increasing the temperature of the reaction mixture and adding the methyl-methacrylate monomer and the peroxide initiator to the reaction mixture, in order to perform the graft-polymerization.

8. The method of claim 7, wherein the solvent is selected from dimethyl carbonate, ethyl acetate, cyclohexane, methylcyclohexane, acetone, toluene and combinations thereof.

9. The method of claim 1, wherein the graft-polymerization is performed at a temperature from 60 to 120° C.

10. The method of claim 1, wherein the weight ratio of methyl methacrylate monomer to main polymer is from 1:10 to 1:1.

11. The method of claim 1, wherein the weight ratio of peroxide initiator to methyl methacrylate monomer is from 1:1000 to 1:10.

12. The rubber obtainable by the method of claim 1.
